(19) United States
(12) Patent Application Publication
(10) Pub. No.: US 2007/0061714 A1
(43) Pub. Date: Mar. 15, 2007

(54) Quick styles for formatting of documents

(75) Inventors: Stuart J. Stuple, Redmond, WA (US); Joseph F. Friend, Bothell, WA (US); Katsuhiro Namba, Seattle, WA (US); Mashiur Rahman, Kent, WA (US); Nathan R. Burch, Bothell, WA (US); Susan M. Baker, Snohomish, WA (US); Xue Gong, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/301,500

(22) Filed: Dec. 13, 2005

Related U.S. Application Data
(60) Provisional application No. 60/715,831, filed on Sep. 9, 2005.

(51) Int. Cl. G06F 17/00

(52) U.S. Cl. 715/529

(57) ABSTRACT

Users may quickly format their document in a natural way without having to understand the intricacies of how styles work. With quick formatting, the user can easily capture the look of an element, assign a name, and then have that element available in their document as well as their user interface. For example, a user could format a paragraph by indenting and italicizing the content and then store that style as an item within a quick format user interface (UI). A user may also capture one or more styles from a first document and make them available in a second document without having to copy the previously formatted content from the first document to the second document. These styles may be stored within the quick format UI such that they may easily be accessed at a later time.

### RELATED APPLICATION(S)

This utility patent application claims the benefit under 35 United States Code § 119(e) of U.S. Provisional Patent Application No. 60/715,831 filed on Sep. 9, 2005, which is hereby incorporated by reference in its entirety.

### BACKGROUND

Documents may be formatted a variety of different ways. Formatting a document, however, can be tedious and updating a document that includes direct formatting may be even more difficult. Typically, a user creates a document and may directly format the headings, paragraphs, text, tables, lists, and the like. A user may also apply styles to all or part of the document. For instance, a user may apply a style to format the headings within the document and then directly format the paragraphs within the document. Users may also want their inserted drawings, such as charts and diagrams, to have a consistent look to the text and headings within their document. In order to accomplish this, the user must have knowledge of styles and formatting options that are available within the application.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Users may quickly format content within their document in a natural way using quick styles without having to understand the intricacies of how styles work. With quick styles, a user can easily capture the look of formatted content, assign a quick style name to that content, and then have that quick style available to them to apply to other content within their current document or another document. For example, a user could format a paragraph by indenting and italicizing the content and then store that quick style as an item within a quick style user interface (UI). A user may also capture one or more quick styles from a first document and make them available in a second document without having to copy the formatted content from the first document to the second document. These quick styles may be stored within the quick format UI such that they may easily be accessed at a later time.

### BRIEF DESCRIPTION OF THE DRAWINGS

FIG. 1 illustrates an exemplary computing architecture for a computer;

FIG. 2 illustrates a quick style formatting system;

FIG. 3 shows exemplary quick style user interfaces;

FIG. 4 illustrates a quick format list library;

FIG. 5 illustrates a theme picker user interface;

FIG. 6 illustrates a theme colors picker and a theme effects picker;

FIG. 7 illustrates a font picker UI; and

FIG. 8 illustrates a context menu that is associated with a quick style, in accordance with aspects of the present invention.

### DETAILED DESCRIPTION

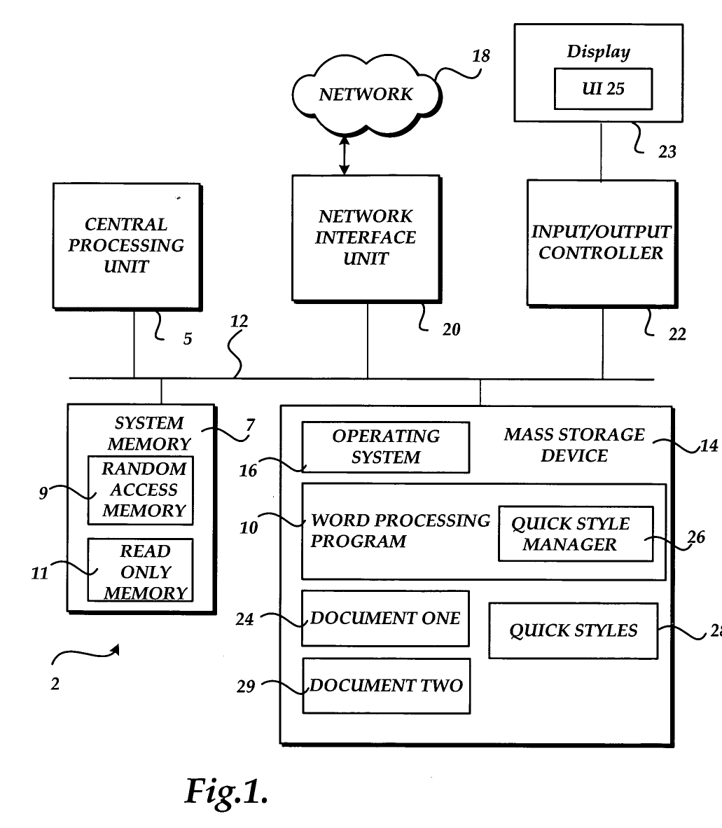

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices. When reading the discussion of routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

Throughout the specification and claims, the following terms take the meanings associated herein, unless the context of the term dictates otherwise.

The term “run” refers to a series of characters that share the same formatting.

The term “range” refers to a user selection.

The term “direct formatting” refers to formatting applied above any settings defined in a style. When formatting from the direct formatting and the style is mutually exclusive, the direct formatting serves as the “top-most” formatting and is shown to the user.

The term “character style” applies to the selected range. This can include font, border, and language settings. The font and language settings are applied above any settings defined in other styles; text borders are applied to the character range and can fall within the paragraph borders.

The term “paragraph style” applies to the entire paragraph. This can include font, paragraph, tab, border, language, frame, and numbering settings. Paragraph, tab, and numbering settings are stored at the paragraph level. Font and language are set for each character run in the paragraph. Paragraph borders are distinct from either text (character or range) borders or table cell borders and can surround text borders and be inside of table cell borders. A frame determines where on the page a paragraph is displayed (it sits between the paragraph and the page in the layout hierarchy).

The term “linked style” refers to a style that can be applied either as a character style or paragraph style. Linked styles represent a special class of paragraph styles that may create character styles “on-the-fly” by applying the style to a range of text. Linked styles are distinguished from paragraph styles or character styles in the UI.

The term “list style” refers to a series of number formats that are linked together to represent the different levels associated with numbering or bulleting. Ideally, levels are related directly to level of indent; however, their actual implementation is independent of indent and relates primarily to list styles. A number format may include the definition of the number (sequence used and punctuation) as well as some paragraph properties (particularly, left margin, hanging indent, and a single tab stop). In addition to the number format, any level within a list style may also be associated with a paragraph style; in such cases, the settings of the paragraph style are above those of the number format. According to one embodiment, a list style has nine levels defined. A list style may further define formatting to be used for the paragraphs at each level by associating a paragraph style with that level. When that level is applied from the list, the paragraph style is also applied. Likewise, when the paragraph style is applied, a level from the list may be applied.

The term “table style” refers to a collection of style settings for the various components of a table: top left cell, top right cell, bottom left cell, bottom right cell, header row, last row, left column, right column, row banding, even row stripes, column banding, and even column stripes. The order of the previous list reflects the stacking of the definitions (with those listed first being above those following). Table styles can include definitions for font and paragraph formatting but are at the bottom of the hierarchy (so the formatting is usually overridden by other styles). Table cell borders appear outside of any paragraph or text borders.

The term “quick style” refers to a style that is identified as one of the styles to show in a quick format user interface.

The term “recommended styles” refers to styles that have been identified to appear in a styles gallery.

The term “recommended priority” refers to a setting for determining the order in which the styles appear in a quick style user interface and a styles gallery.

Referring now to FIG. 1, an illustrative computer architecture for a computer 2 utilized in the various embodiments will be described. The computer architecture shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 may also include an input/output controller 22 for receiving and processing input from a number of other devices, including a keyboard, mouse, or electronic stylus (not shown in FIG. 1). Similarly, an input/output controller 22 may provide output to a display 23, a printer, or other type of output device.

As mentioned briefly above, a number of program modules and data files may be stored in the mass storage device 14 and RAM 9 of the computer 2, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store a word processing application program 10. The word processing application program 10 is operative to provide functionality for creating, editing and formatting electronic documents, such as the document 24. According to one embodiment of the invention, the word processing application program 10 comprises the MICROSOFT WORD word processing application program from MICROSOFT CORPORATION. Other word processing applications and document layout programs from other manufacturers may also be utilized. For instance, desktop publishing programs, presentation programs, web browsers, and any other type of program that utilizes styles in a document may be used.

In conjunction with the editing of a word processing document, the word processing application program 10 provides functionality for providing a Quick Style UI 25 for formatting content within a document, such as document one 24 and document two 29. Quick style manager 26 is configured to apply quick styles 28 to content within a document in conjunction with application program 10. While quick style manager 26 is shown as part of application 10, quick style manager 26 may be separate from application 10. Generally described, users may quickly format their documents in a natural way by applying one or more quick styles 28 to content within a document without having to understand the intricacies of how styles work. The user can easily create a quick style by capturing the look of formatted content, assign a quick style name to that content, and then have that quick style available to them within quick style user interface 25 for application to content within the current document and/or another document. For example, a user could format a paragraph within document one 24 by indenting and italicizing some of the content and then store the styling of that content as a quick style within quick styles 28. That quick style may then be available within UI 25 and may be easily transferred to other systems such that other users could use the quick style. A user may also capture one or more quick styles from another open document on the system. For example, a user could obtain a quick style from document two 29 and make that quick style available to them in their current document, such as document one 24, without having to copy the formatted content from document two 29 to document one 24.

These quick styles may be stored within a quick styles store 28 and presented within a quick style UI such that the quick styles may be easily accessed and applied to elements within a document. The quick styles may also be saved in a set of quick styles such that quick style sets may easily be replaced. According to one embodiment, quick styles are simply styles that have been marked with a property to identify them as a quick style.

Users are able to apply these quick formats to obtain a consistent looking, well formatted document without a major investment in learning a variety of tools. By default, newly inserted content is formatted consistently with the other content that is used within the document. In this way, the charts, drawings, diagrams, and tables within the document can have the same consistent visual starting point while still allowing the user to change or replace that formatting.

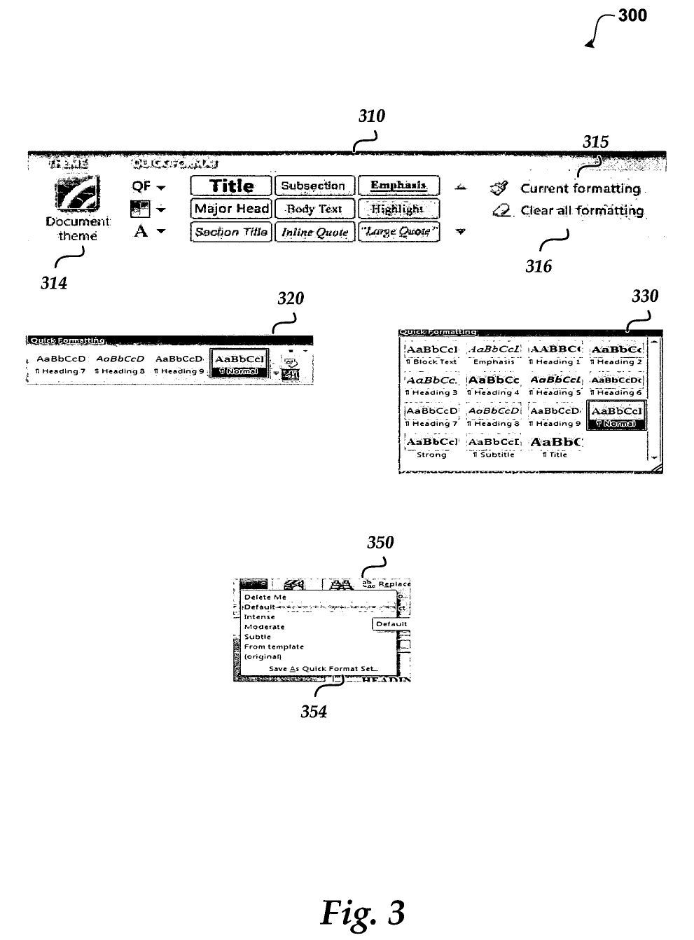

Quick style UI 25 displays the quick styles to a user. According to one embodiment, the quick styles may be accessed from a layout ribbon user interface and may be displayed in a drop down menu (See FIG. 3). The quick styles may also be prioritized such that they are displayed in a particular order.

When hovering over a quick style, a live preview of the quick style is provided to the user through display 23. For example, when a user is hovering over one of the quick style UI buttons, the quick style may be temporarily applied to a paragraph within the document. The quick style may also be applied to a current selection and/or to a default content that is associated with the preview. This preview allows a user to see how content would be formatted if the quick style is selected.

In some cases, the user may have applied both a quick style and direct formatting. When the start of the selection contains additional formatting above the quick style, then the quick style appears within UI 25 as depressed but also grayed. This is to inform the user that they can use the button to remove the quick style formatting but that it may not remove all formatting. This provides a visual cue to the user for them to select a clear all formatting button from UI 25 to remove all of the formatting from the content.

Quick styles may be created from any combination of formatting options that are applied to content within a document. For example, a user may format their document using a specific font, font size, bold, italic, underline, and color controls to content within the document. The user may save these formatting options as a quick style. The user may also select from a set of pre-defined combinations of these styles. Additional details regarding the quick formatting will be provided below.

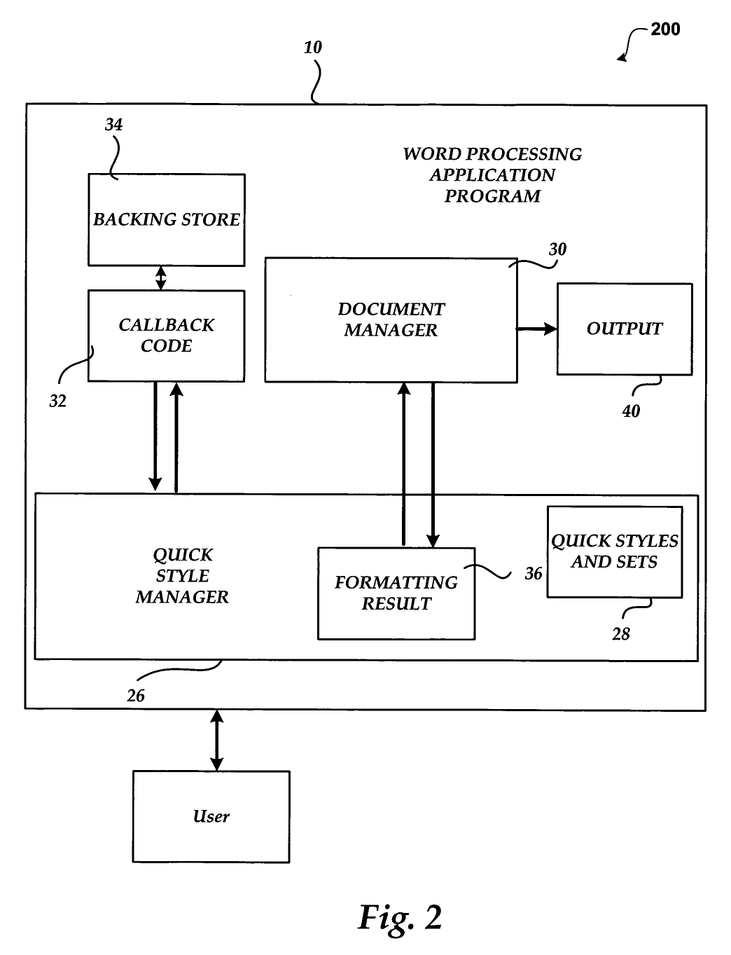

FIG. 2 illustrates a quick style formatting system 200, in accordance with aspects of the invention. The quick style manager (QSM) 26 provides document layout and formatting services associated with quick styles 28 for application 10. According to one embodiment, documents that are associated with application 10 may be stored in a backing store 34. In order to facilitate communication with the QSM 26, one or more callback routines, illustrated in FIG. 2 as callback code 32 may be implemented. Through the use of the callback code 32, the QSM 26 may query for additional information necessary to format various portions of the document using one or more quick styles 28.

As will be described in greater detail below, the QSM 26 provides facilities for formatting a document using quick styles 28. The QSM 26 provides these facilities in response to a request from the application program 10. The document manager 30 may communicate with the QSM 26 to request that at least a portion of the document be formatted using a quick style. The document manager 30 may also provide to the QSM 26 the text and other content from the document that should be formatted. The document manager 30 may initially provide some of the content to the QSM 26. The QSM 26 may then request additional content from the callback code 32 as needed to format the content. The document manager 30 may also indicate to the QSM 26 the quick style 28 to be applied to the document.

As discussed above, formatting content within a first document may be applied to content within a second document without having to explicitly copy the content that contains the formatting from the first document into the second document. With prior art systems, once the second document had been initially created, there was no easy way to make the formatting of the second document match the first document. The user could change the look of the second document by manually formatting elements within the second document. The user could update the style definitions which may be a complex task and is rarely done, or the user could attach a template that may result in an unpredictable outcome. The use of a template, however, requires an indirect approach that must be implemented when first creating the second document.

A user may select from one or more of the available quick style sets 28. According to one embodiment, more than one set of quick styles may be available at any one time. For example, a user may change the look and feel of the formatting for a document by changing the quick style set. The user may also change the quick style collections of looks and the font/color definitions and save the quick style within a new quick style set or overwrite the existing quick style set. For instance, the user may have two collections of colored headings: email (8 pt, 10 pt, and 12 pt) and corporate reports (10 pt, 12 pt, and 13 pt bold). The user may want to be able to change the colors and fonts used independently of the formatting set. So if the user has two color/font sets: Red/Arial and Blue/Verdana, they may want to be able to switch each of the pairs independently resulting in four completed quick style sets. These four completed sets may include: Red/Arial email (Red 8 pt Arial, Red 10 pt Arial, and Red 12 pt Arial); Blue/Verdana email (Blue 8 pt Verdana, Blue 10 pt Verdana, and Blue 12 pt Verdana); Red/Arial corporate reports (Red 10 pt Arial, Red 12 pt Arial, and Red 13 pt bold Arial); and Blue/Verdana corporate reports (Blue 10 pt Verdana, Blue 12 pt Verdana, and Blue 13 pt bold Verdana).

The current document that is open stores its own copy of the quick style set that it is using. The user can save this set to any machine such that they have their own copy of this quick style set. That set can be replaced by any of the ones on a menu of available quick style sets. When this occurs, the text formatted with the corresponding name in the document is updated to match the new definitions.

In a multi-user environment, when the user then shares the document including these quick styles with another user they may want that user to be able to use those same quick styles on their own system. When the user delivers the document, any quick styles used within the document are included. In this way, other users may easily incorporate these quick styles within the same document or other documents.

The following table illustrates what occurs, according to one embodiment, when a quick style is applied to a range of content.

| Style Type | Range Span | Results when style is applied |
|---|---|---|
| Character | Any | Applied to all text within range |
| Paragraph | Any | Applies to each paragraph of |
| | | which any character is included |
| | | in the range |
| Linked | Does not include | Applied to text within the range |
| | paragraph mark | but not to the paragraph. |
| Linked | Includes only paragraph | Is applied to entire paragraph |
| | mark | |
| Linked | Includes paragraph mark | Applies to each paragraph of |
| | and the following character | which any character is included |
| | | in the range |
| Linked | Does not include first | Applies to the text within the |
| | character of the paragraph | range |
| | but does include the | |
| | paragraph mark | |

FIG. 3 shows exemplary quick style user interfaces 300. Generally, a quick style UI displays a visual gallery of “buttons” representing the available quick style formatting options. For example, example quick style UI 320 shows a reduced number of quick style buttons as compared to quick style UI 330 that shows more quick style buttons. The quick style entries within the UI may be configured by a user. For example, the quick style buttons could be arranged by an order of importance, a type of quick style (i.e. headings, titles, etc . . . ), alphabetically, most used, most recently used, and the like.

A quick style may be associated with a document theme. Generally, a theme consists of theme fonts (heading and body), theme colors (a set of colors that may then be lightened or darkened), and a collection of effects including, but not limited to: line styles and weights, fills (pattern, gradient, and/or picture), shadow effects and transparency effects. Whenever a new theme is selected, any quick styles that are associated with a theme are updated to reflect the newly selected scheme. Document themes may be accessed through ribbon interface 310 using button 314.

Quick style UI 350 is configured to perform actions relating to quick styles. For example, using selection 354 a user may save a quick style set such that the quick styles may be used with another document and/or saved for later use. These quick style sets travel with the document and then they may be saved on a new machine. Referring to quick style UIs 320 and 330 it can be seen that each of the quick styles include a name and a text string that are rendered using the style. This allows a user to better visualize how the quick style will format the selected content.

If there are more quick styles than can be displayed in the available UI space, then a standard control is used to indicate that the gallery can be expanded to drop down an expanded gallery that shows all the available quick styles. If there are fewer quick styles than can be displayed in the available UI space, then the quick styles may be evenly divided into rows of equal length and the gallery control shortened to show the ribbon background.

Quick style UI 310 includes an option 315 for painting content within a document with a quick format. When the user selects paint option 315, a format paint brush is loaded with the formatting that is associated with the current selection. Dragging the brush across other content within the document formats that content according to the initial loading of the brush. According to one embodiment, the brush stays loaded by default and a user can continue to paint other content within the document. If the user is in format painting mode, and selects on any other quick style, then the selected quick style is applied and format painter mode is cancelled. Quick styles follow the same application rules as the styles on which they are based. A range of text has only one character style applied. The text within a paragraph has the same paragraph style applied. A text range may have a linked style applied as a character style and another style applied as a paragraph style (for instance, a range of Heading 2 text within a Heading 1 paragraph is possible if Heading 2 is a linked style—Heading 1 can be either linked or paragraph in this case). A paragraph has one paragraph style applied. Applying a paragraph style removes all paragraph formatting and any character formatting that has been applied to more than 50% of the paragraph. Applying a character style removes the character formatting except that which is being applied via the paragraph style. Applied quick styles may be removed from content within a document by selecting the quick style button that applied the formatting. This can be compared to bolding and unbolding, italicizing and removing italicizing, and underlining and removing underlining. According to one embodiment, any direct formatting that has been applied to the content is not removed. When the selection contains some text with the quick style and some without the quick style formatting, then the first click applies the quick style to all the text and the second click removes the quick style from all the text. A user may also remove all of the formatting from a selection by using a clear all formatting option. According to one embodiment, the user may select a “Clear all formatting” eraser 316 to remove the quick style from the elements.

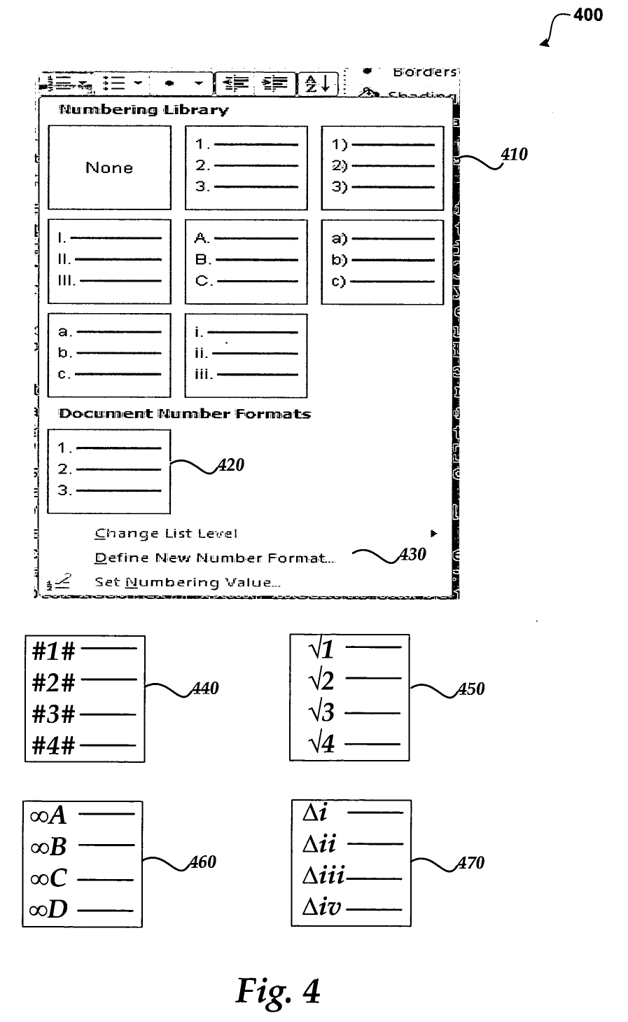

FIG. 4 illustrates a quick format list library. With bullets and numbers, the quick style gallery aggregates numbering and bullet information from the system. According to one embodiment, the information is obtained from a stored numbering file as well as from any open documents on the system. For example, a document that is open on the system may include other numbering and/or bullet schemes. According to one embodiment, the user can right-click on a numbering format from any currently opened document and add it to their quick style library. They can also right-click on any quick style that is contained within the library and remove it. A new number and/or bullet format may also be defined using the “Define New Number Format . . . ” menu option 430. The number format may be any format desired by a user. For example, the numbering format may be a standard numbering format such as shown within UI 410 or a custom numbering format such as the four illustrated in FIG. 4 (See 440, 450, 460, 470). Although not shown in UI 410, these custom formats are generally displayed within UI 410.

At any time, a user can define a new bullet and/or numbering scheme. That scheme is then available within library 410 and travels with the document. So, imagine that the document is sent to another computer and the other computer doesn't have this entry in their bullet library. When the user opens the document with the new scheme it is available to the user. According to one embodiment, when the user wants to include a new quick style onto their system for use with other documents they manually save the quick style. According to another embodiment, the system automatically saves the quick style.

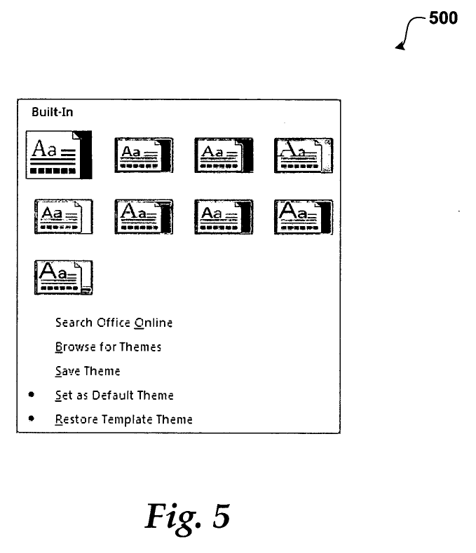

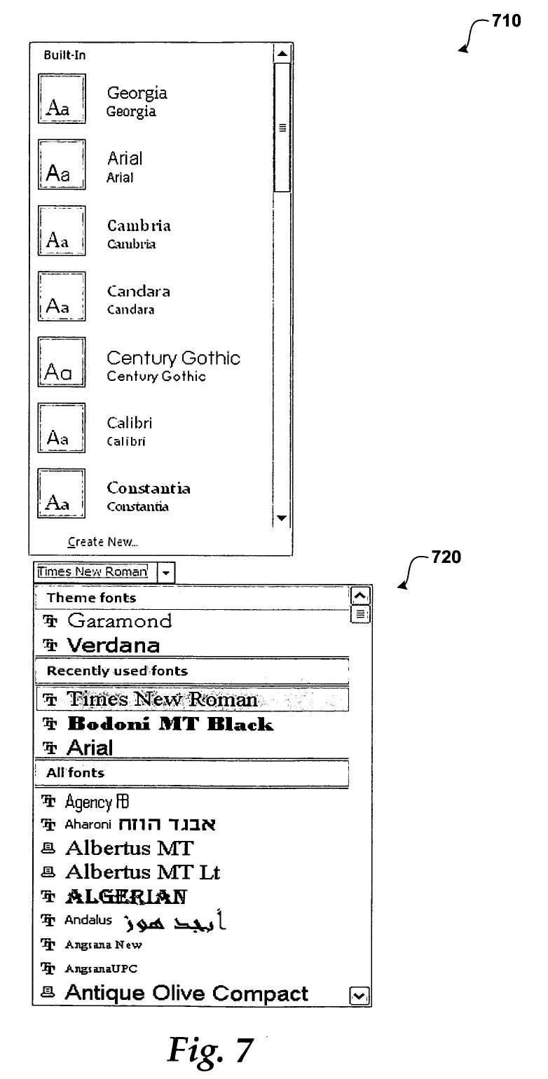

FIG. 5 illustrates a theme picker user interface. As discussed above, one or more of the quick styles may be associated with a theme. Additionally, a theme may be created and/or modified by a user. For example, a user may associate a minor and major font using a font picker (See FIG. 7). As illustrated, theme UI 500 includes a section for custom themes and a section for standard themes. A user may also browse for more themes. Each quick style that is associated with a theme is based on a style rather than a value. In other words, changing the theme in turn changes any quick style formatting that is based on a theme. According to one embodiment, objects, including charts and drawing objects, by default have characteristics based on a current theme.

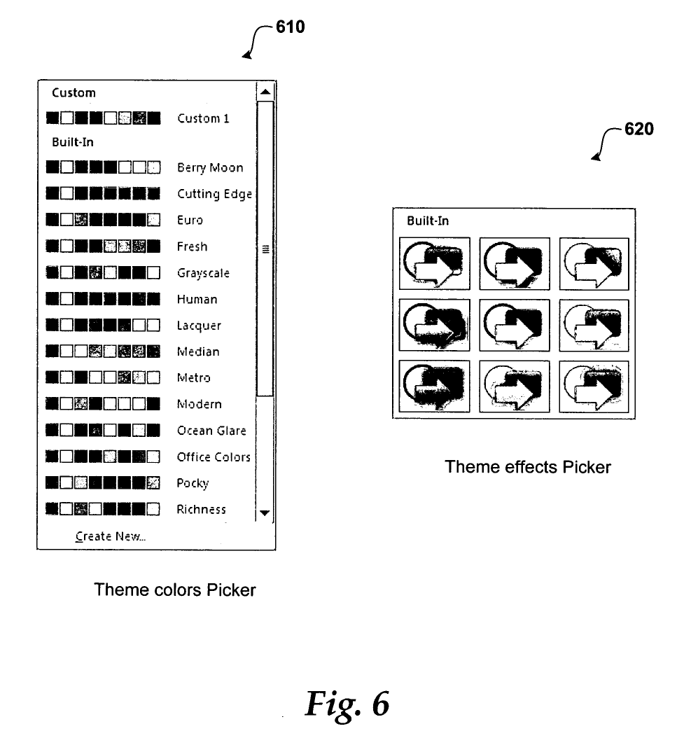

As briefly discussed above, a user may select options that are associated with a theme. According to one embodiment, three “scheme” UI pickers are used to select options, including a font picker, color picker, and effects picker (See FIGS. 6 and 7). Changing a value in one of the scheme pickers correctly updates the corresponding values in the document itself. In particular, theme-aware fonts change whether defined as part of a style or as direct formatting.

FIG. 6 illustrates a theme colors picker 610 and a theme effects picker 620. The user may choose to use theme colors, use customized color schemes and standard color schemes. When the color schemes do not fit within the UI, then the other schemes may be accessed by a scroll bar. Alternatively the user may choose to select the more color schemes option and the user may also decide to create and/or customize a color scheme. Changing the values in the theme colors picker 610 correctly updates the corresponding values in the document itself. In particular, theme-aware colors change whether defined as part of a style or as direct formatting.

The effects picker 620 is used wherever the current UI provides controls for setting the Fill. Effects picker 620 shows pattern fill choices (color and gradients). As can be seen more effects may be added within effects picker UI 620. When saving back to an older format the theme information may be flattened to set values stored in the text styles and objects such that backwards compatibility is maintained.

FIG. 7 illustrates a font picker UI. Font picker UI 710 includes custom font schemes and standard font schemes. A user may also customize a font scheme. Font picker UI 720 shows theme fonts, recently used fonts, and all of the other fonts. As illustrated, the font picker UI 720 includes theme fonts Garamond and Verdana. When one of these fonts is selected, they follow the currently selected theme. According to one embodiment the two base fonts are determined by frequency of use within the document. The most frequently used font is assigned to the Minor (Body) font and the second most frequently used font is assigned the Major (Heading) font. According to another embodiment the assignment is done based on the functional use of the fonts with the organizational structure of the document content. According to one embodiment, this calculation is done separately for each of three script sets (for a possible total of six font assignments).

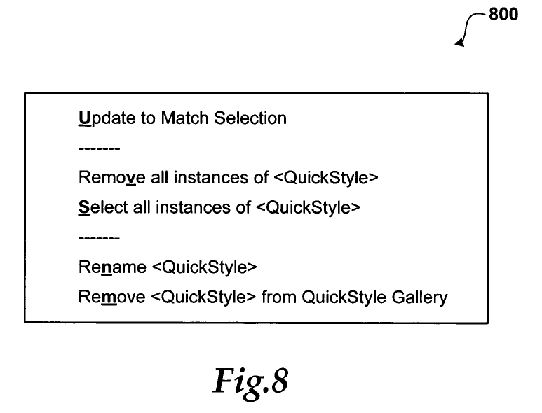

FIG. 8 illustrates a context menu that is associated with a quick style. According to one embodiment, a user may right click to bring up context menu 800. As illustrated, context menu 800 includes: update to match selection command; remove all instances of a quick style; select all instances of a quick style; rename a quick style and remove a quick style from the quick style gallery.

The Update to Match Selection command on the context menu 800 updates the quick style to include the formatting options that are associated with selected content within a document. The Remove All Instance command selects all of the content that is currently formatted with the quick style and then removes that quick style. According to one embodiment, the selection of the content remains after the formatting that was associated with the quick style has been removed. The Select All Instances command selects the content that is currently formatted with the quick style. The Rename command allows the user to change the name of an existing quick style. When the Remove Quick Style command is selected from the context menu, the quick style is removed from the quick style gallery by changing a corresponding property on the style. In other words, the style itself is not deleted but its reference as a quick style is deleted.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for quickly formatting a document, comprising:
determining quick styles that are available to the document; wherein one or more of the quick styles may be applied to content within the document and wherein a quick style may be defined by selecting content within the document that has formatting applied to it and saving the style as a quick style;
arranging the quick styles within a user interface for selection;
determining when one of the quick styles that is arranged within the user interface is selected; and
applying the quick style to content within the document.

2. The computer-implemented method of claim 1, wherein determining the quick styles that are available to the document comprises determining quick styles that are available within at least one of: a second document that is currently open and a file that includes a saved quick style.

3. The computer-implemented method of claim 2, further comprising obtaining the quick styles and placing the obtained quick styles within the user interface for selection; wherein obtaining the quick styles from the second document is completed without copying formatted content from the second document to the first document.

4. The computer-implemented method of claim 2, further comprising associating a theme with at least one of the quick styles.

5. The computer-implemented method of claim 4, wherein the theme includes fonts and colors that are associated with the theme.

6. The computer-implemented method of claim 2, further comprising selecting content within the document and providing a preview of at least a portion of the content using one of the quick styles.

7. The computer-implemented method of claim 1, wherein determining the quick styles that are available to the document comprises determining quick styles that relate to at least one of: a bullet scheme and a numbering scheme.

8. The computer-implemented method of claim 2, wherein applying the quick style maintains direct formatting that is applied to the content.

9. The computer-implemented method of claim 2, wherein applying the quick style comprises painting the quick style onto the document.

10. The computer-implemented method of claim 2, wherein arranging the quick styles within the user interface for selection comprises arranging the quick styles according to a recommended priority.

11. A computer-readable medium having computer executable operations for quickly formatting content within a document by applying a quick style, comprising:
obtaining quick styles; wherein obtaining the quick styles involves obtaining quick styles from a second document that is currently open and wherein the document does not include the quick styles from the second document and from any saved quick styles that are selected to be obtained from a file;
arranging the quick styles within a user interface for selection;
determining when one of the quick styles is selected; and
applying the quick style to content within the document.

12. The computer-readable medium of claim 1 1, further comprising associating a theme with at least one of the quick styles.

13. The computer-readable medium of claim 12, wherein associating the theme comprises defining a theme by associating colors and fonts with the theme.

14. The computer-readable medium of claim 12, further comprising providing a preview of the content using one of the quick styles.

15. The computer-readable medium of claim 1 1, wherein determining the quick styles that are available to the document comprises determining quick styles that relate to at least one of: a bullet scheme and a numbering scheme.

16. The computer-readable medium of claim 12, wherein applying the quick style comprises painting the quick style onto the document.

17. A system for quickly formatting content within a document, comprising:
means for obtaining quick styles; wherein obtaining the quick styles involves obtaining quick styles from at least one of: a saved quick style set; and a second document that is currently open and wherein the document does not include the quick styles from the second document;
means for arranging the quick styles within a user interface for selection;
means for determining when one of the quick styles is selected; and
means for applying the quick style to content within the document.

18. The system of claim 17, further comprising means for associating a theme with at least one of the quick styles; wherein associating the theme comprises defining a theme by associating colors and fonts with the theme.

19. The system of claim 17, further comprising means for providing a preview of the content using one of the quick styles.

20. The system of claim 17, further comprising means for painting the quick style onto the document.
